(19) United States
(12) Patent Application Publication
(10) Pub. No.: US 2013/0273418 A1
(43) Pub. Date: Oct. 17, 2013

(54) BATTERY

(71) Applicant: Akinori Saito, Ariya-shi (JP)

(72) Inventor: Akinori Saito, Ariya-shi (JP)

(73) Assignee: Toyota Jidosha Kabushiki Kaisha, Aichi (JP)

(21) Appl. No.: 13/995,628

(22) PCT Filed: Dec. 22, 2010
(86) PCT No.: PCT/JP2010/073171

§ 371 Date: Jun. 19, 2013

(51) Int. Cl. H01M 2/30

(52) U.S. Cl. CPC H01M 2/30
USPC 429/179

(57) ABSTRACT

The battery of the present invention is provided with: a case having through holes; external terminals fixed in the through holes in the case in a state with part thereof protruding to the outside of the case; insulating members interposed between the case and the external terminals; flanged portions located at the peripheral edges of the through holes in the case protruding outward of the case; and reinforcing members that are disposed at the outer periphery of the flanged portions and reinforce the strength on the outer peripheral side of the flanged portions. The battery is such that the external terminals are secured in the through holes by making the flanged portions undergo plastic deformation by pressing and generating a sticking force between the external terminals and the through holes by the parts of the flanged portions that have undergone plastic deformation. The external terminals are provided with a first projection that is formed more to the outside of the case than the location receiving the sticking force due to the pressing of the flanged portion and protrudes to the outside in the radial direction from the outer peripheral surface of the external terminal.

### TECHNICAL FIELD

The present invention relates to a battery, particularly to a technique of fixing an external terminal to a case.

### BACKGROUND ART

The case of the battery contains a power generating element. The external terminals (positive and negative terminals) are fixed to the outside of the case, projecting outward through the case. The external terminals are electrically connected to the power generating element, and the electric power is transmitted through the terminals between inside and outside of the battery.

If the battery is a nonaqueous electrolyte secondary battery such as a lithium ion secondary battery, the contamination of water into the battery has an influence on the battery performance, so that the high sealing property is needed.

Moreover, at the fitted portions of the external terminals into the case, it is required to keep the fitting property of the terminals not to slip out from the case, the sealing property for preventing from leakage of the electrolytes contained in the case and of gases generated in the battery, and the insulating property between the terminals and the case. In short, the sufficient sealing performance between the case and the terminals is required.

JP 2005-302625 A discloses a battery having an electric terminal projecting from a lid of the case, in which an insulating member is arranged between the lid and terminal and the lid is provided with a flanged portion standing out around the insulating member. The flanged portion is pressed and deformed from the direction perpendicular to the flanged portion, whereby the external terminal is press-fitted to the lid.

Unfortunately, according to the use of the battery, a temperature cycle including heating and cooling is repeated, whereby the press-fitted portion may be loosened to return the former shape and the sealing property may be degraded.

### CITATION LIST

### Patent Literature

PTL 1: JP 2005-302625 A

### SUMMARY OF INVENTION

### Technical Problem

The objective of the present invention is to provide a battery including a case and external terminals fitted to the case with projecting therefrom, provided with high sealing property at the fitted portion between the case and terminals.

### Technical Solutions

The first embodiment of the present invention is a battery that includes: a case provided with through holes; external terminals fixed in the through holes of the case, projecting outward; insulating members interposed between the case and the external terminals; flanged portions located at the periphery of the through holes, standing out from the case; and reinforcing members located around the flanged portions to reinforce strength thereof in radial direction. The flanged portions are pressed and plastically deformed so as to generate a sticking force between the external terminals and the through holes by the plastically deformed portion, whereby the external terminals are fixed to the through holes, and each of the external terminals includes a first projection formed at outer side of the portion Where the sticking force acts, projecting radially outward from the outside of the external terminal.

In the preferable embodiment, each of the external terminals includes a groove formed at the portion where the sticking force acts, and the first projection is located outer side of the groove, and each of the external terminals further includes a second projection formed at inner side of the groove, projecting radially outward from the outside of the external terminal.

The first and second projections are advantageously formed continuously to the edges of the groove.

In the advantageous embodiment, the battery further includes current collecting terminals connecting a power generating element and the external terminals, each of the current collecting terminals connected to the inner end of the external terminal and extending beyond the outer periphery of the external terminal, and each of the current collecting terminals holds the inside of the insulating member with the first or second projection.

### Advantageous Effects of Invention

The battery according to the present invention is provided with high sealing property at the fitted portion between the case and terminal.

### BRIEF DESCRIPTION OF DRAWINGS

FIG. 1 depicts a battery.

FIG. 2 is an enlarged section view of a fitted portion between a case and an external terminal.

FIG. 3 depicts the external terminal.

FIG. 4 shows the situation where the axial force is acted on the terminal.

FIG. 5 shows the situation where the radial force is acted on the terminal.

FIG. 6 illustrates an alternative projection of the external terminal.

FIG. 7 shows actions of the projection and a current collecting terminal where the projection of the external terminal and the current collecting terminal hold a part of the insulating member, (a) shows the case that the outer force acts on the external terminal in the axial direction, and (b) shows the case that the outer force acts on the external terminal in the radial direction.

FIG. 8 depicts an alternative battery, in which the external terminal includes two projections formed at the upper and lower ends of the groove.

FIG. 9 shows the action of the projections where the outer force acts on the external terminal, (a) shows the case that the outer force acts in the axial direction, and (b) shows the case that the outer force acts in the radial direction.

FIG. 10 illustrates other battery, in which the external terminal includes two projections, and the projection disposed at the side of the current collecting terminal and the collecting terminal hold the part of the insulating member.

### DESCRIPTION OF EMBODIMENTS

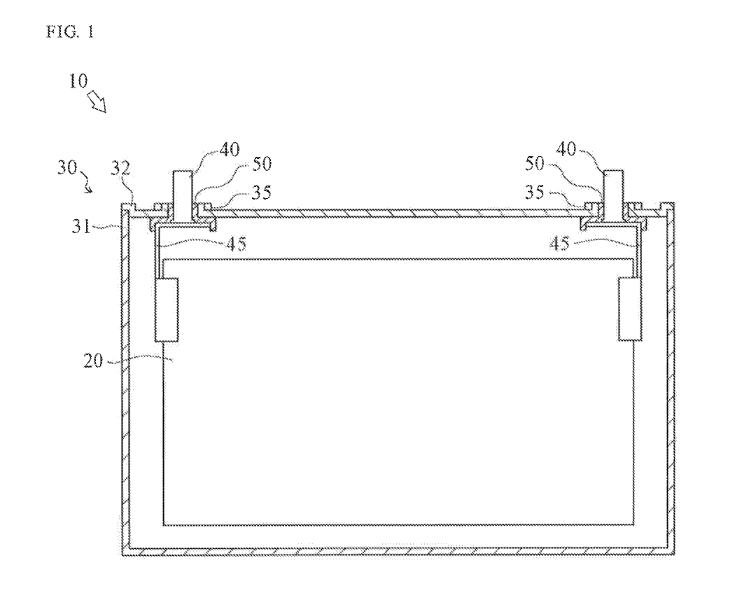

Referring to FIG. 1, the structure of a battery 10 as an embodiment of the present invention is explained below. The battery 10 is a lithium ion secondary battery.

The battery 10 includes a power generating element 20, a case 30 containing the power generating element 20, two external terminals 40 projecting outward from the case 30, and two insulating members 50 interposed between the case 30 and the terminals 40.

The power generating element 20 is an electrode body with electrolyte impregnation, which is formed by laminating or winding a positive electrode, a negative electrode and a separator. When charging or discharging the battery 10, a chemical reaction occurs in the element 20 (in detail, the ion moves between the positive and negative electrodes via the electrolytes), and thus the electric current is generated.

The case 30 is a square can, including a box 31 and a lid 32. The box 31 has a closed-end shape and an opening at one side, and contains the element 20. The lid 32 has a shape in accordance with the opening of the box 31, and covers the opening of the box 31. The lid is fixed to the box 31.

The external terminals 40 are located at the outside of the lid 32 extending outward of the battery 10. Each of the terminals 40 is connected to the positive electrode or negative electrode of the element 20 via a current collecting terminal 45. The external terminals 40 and the current collecting terminals 45 work as current paths for taking out the electric power from the element 20 or taking in the electric power from outside.

Each of the current collecting terminals 45 is connected to the positive electrode plate or negative electrode plate of the element 20. The material for the collecting terminal 45 may be aluminum for the positive electrode or cupper for the negative electrode.

The external terminal 40 has a thread portion formed by thread rolling at the projected part from the battery 10. if the battery 10 is actually used, the thread portion of the external terminal 40 is fixed to a bus bar or a connecting terminal of the external device. While fastening, a fastening torque and an axial force due to the bolting act on the external terminal 40, so that the external terminal 40 is preferably made of high strength material such as steel.

The external terminals 40 are fixed in the lid 32 interposed with the insulating members 50, respectively. The insulating member 50 surrounds the external terminal 40, thereby insulating between the case 30 and the external terminal 40.

The insulating member 50 is preferably made of material with fine high-temperature creep characteristic, or the material having the long creep property against the temperature cycle of the battery 10, e.g. PEEK (poly (etheretherketone)), PPS (Poly Phenylene Sulfide Resin).

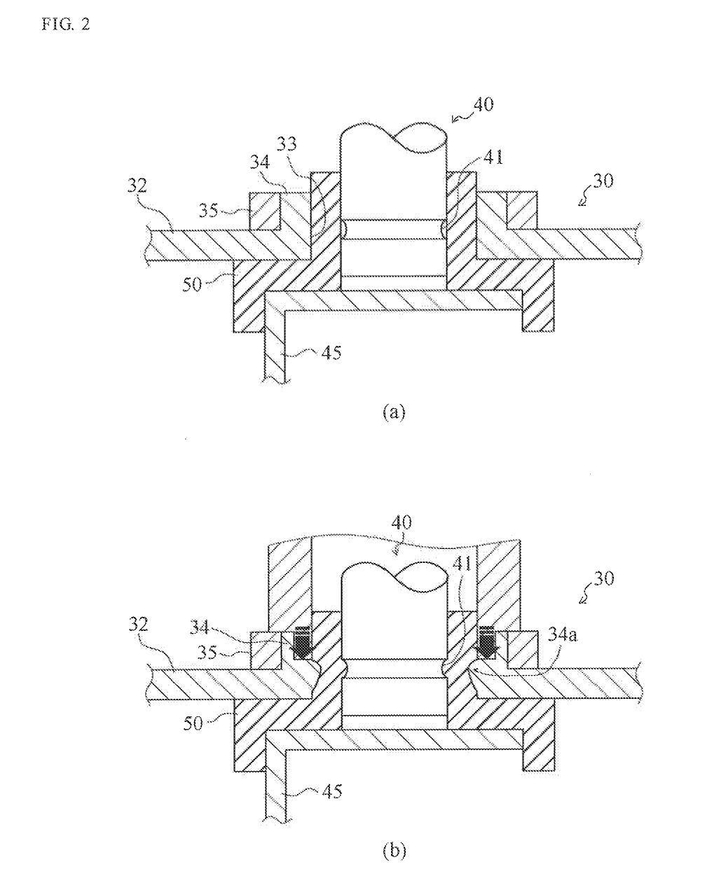

Referring to FIG. 2, the fixing structure between the case 30 and the external terminal 40 is described below.

As shown in FIG. 2(a), the case 30 has a pair of through holes 33 through which the terminals 40 penetrate. The case is provided with flanged portions 34 projecting outward of the case each of which is formed at the periphery of the through hole 33.

The through hole 33 has a predetermined diameter and drilled in the thickness direction of the case 30.

The flanged portion 34 is formed at the edge of the hole 33 and stands out from the case 30 from inside to outside thereof, thereby formed as a thick portion. The part of the case 30 (around the hole 33) is plastically deformed to form the flanged portion 34, which is formed by burring processing, deep drawing, damming, or the combination of these methods.

The flanged portion 34 is surrounded by a reinforcing ring 35.

The reinforcing ring 35 is made of metal material having higher strength than the material of the ease 30 (lid 32), such as steel, and reinforces the flanged portion 34 against the force in the radial direction. The inner diameter of the reinforcing ring 35 is substantially same as the outer diameter of the flanged portion 34.

The insulating member 50 seals the battery 10 as well as insulates between the case 30 and the external terminal 40.

As depicted in FIG. 2(b), the external terminal 40 is arranged in the through hole 33 surrounded by the insulating member 50, and the inside portion of the projected end of the flanged portion 34 is pressed and deformed, whereby the inside part of the flanged portion 34 is extended radially inwardly. Thus, an extended portion 34a is formed inward in the radial direction.

The flanged portion 34 is surrounded by the reinforcing ring 35 that has higher strength than the flanged portion, and therefore, the pressure during the deformation is prevented from loosening and the extended portion 34a is formed such that the part of the flanged portion is expanded inwardly, i.e., toward the external terminal 40.

The inwardly extended portion 34a compresses the insulating member 50, thereby applying the surface pressure to the insulating member 50. In the insulating member 50, the area where the surface pressure from the insulating member 50 acts is elastically deformed inward, and the elastic deformation results in the surface pressure acted on the external terminal 40.

As described above, the projected end of the flanged portion 34 is pressed from the upper side and deformed by the pressing, and the extended portion 34a is formed inwardly, whereby the surface pressure received from the extended portion 34a is transmitted to the external terminal 40 via the insulating member 50. Due to the surface pressure, the external terminal 40 is compressed and fitted in the through hole 33 of the lid 32.

The extended portion 34a is plastically deformed in the direction perpendicular to the pressing direction to fasten the insulating member 50 and the external terminal 40. Therefore, among the case 30, the insulating member 50 and the external terminal 40, there occur strong surface pressure and friction force. As the result of that, the temperature cycle accompanied with the usage of the battery 10 does not influence on the deformation (return) of the extended portion 34a, thereby preventing the loosening of the fixing portion.

The external terminal 40 includes a groove 41 to receive the surface pressure from the flanged portion 34. The groove 41 is a semicircular (or the shape with edge lines such as a semioval) recess formed wholly along the outer periphery of the terminal 40, and has a predetermined groove width.

The insulating member 50 elastically deforms as above-described, so that the insulating member is partially moved into the groove 41 and sticks the edge lines of the groove 41. Thus, the insulating member 50 is attached firmly to the terminal 40, thereby improving the sealing property.

Noted that when pressing the end of the flanged portion 34, the lower dead end of the pressing is advantageously located substantially same as the outer edge of the groove 41. Due to such structure, the edge line of the groove 41 is located where the plastic deformation amount of the extended portion 34a is the largest, and, the bonding strength between the insulating member 50 and the terminal 40 can be efficiently enhanced.

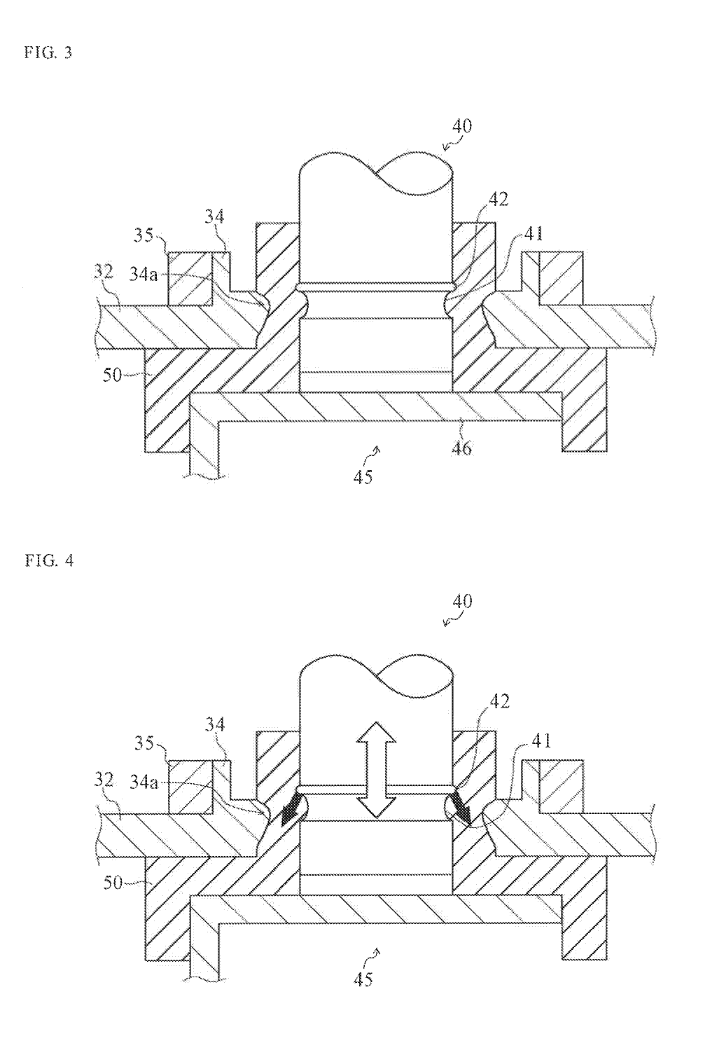

As shown in FIG. 3, the external terminal 40 is formed with a projection 42. The projection 42 is disposed at the outer periphery of the terminal 40 so as to project radially outwardly. The projection 42 is located upper side of the edge line of the groove 41 as the sealing point between the terminal 40 and the case 30. In other words, the projection 42 is formed at more upper side than the portion where the pressure from the flanged portion 34 works (the lower dead end of pressing).

The projection 42 is a protrusion having a semicircular section, which is formed around the terminal 40. The projection 42 is provided above the groove 41, and formed continuously to the upper edge line of the groove 41.

As described above, the projection 42 is located above the groove 41 as the sealing point between the terminal 40 and the insulating member 50, and has the semicircle shape, which involves the surface (lower surface in drawing) facing inside of the groove 41 (inner side of the case 30). The projection 42 of the terminal 40 has effects as follows.

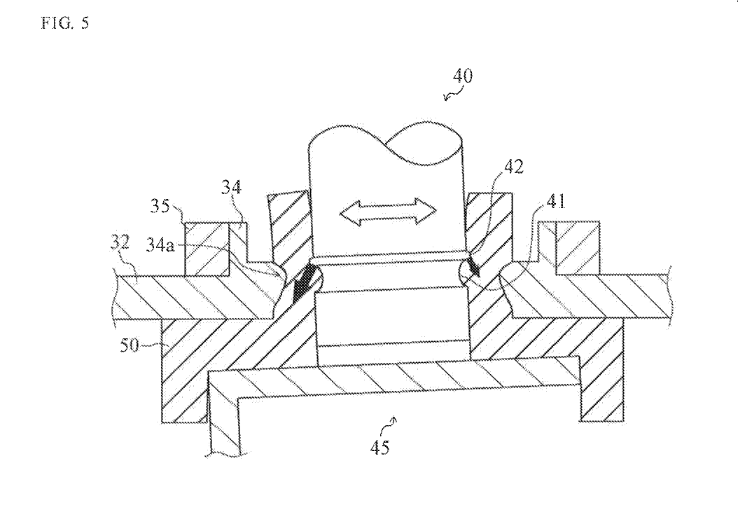

As depicted in FIG. 4, when the axial force (in the vertical direction of the drawing) acts on the external terminal 40, the insulating member 50 attaching to the terminal 40 also receives the axial force. At this time, the lower surface of the projection 42 prevents the insulating member 50 from spreading, or flowing out upward from the upper edge line of the groove 41, thereby damming flow of the insulating member 50 around the groove 41 as the sealing point. Therefore, the insulating member 50 can avoid overcompression and keep the elasticity. As a result, the sticking force at the sealing point among the insulating member 50, the terminal 40 and the case 30 can be maintained, and thus the sealing property can be improved.

When actually using the battery 10, the external terminal 40 is connected with the connecting terminal of the external device by bolting. During the bolting, the bolting torque and the axial force act on the bolt portion of the terminal 40, and particularly large outer force acts in the axial direction. In this embodiment, the projection 42 of the terminal 40 prevents the insulating member 50 from deforming toward the outside by the axial force acted on the terminal 40.

As depicted in FIG. 5, when the radial force (in the lateral direction of the drawing) acts on the external terminal 40, the insulating member 50 attaching to the terminal 40 also receives the radial force. Such outer force in the radial direction might make the insulating member 50 deformed and flown out in the axial direction; however the lower surface of the projection 42 prevents the insulating member 50 from spreading, or applying the reaction force to the insulating member 50. Therefore, the insulating member 50 can avoid overcompression and keep the elasticity. As a result, the sticking force at the sealing point among the insulating member 50, the terminal 40 and the case 30 can be maintained, and thus the sealing property can be improved.

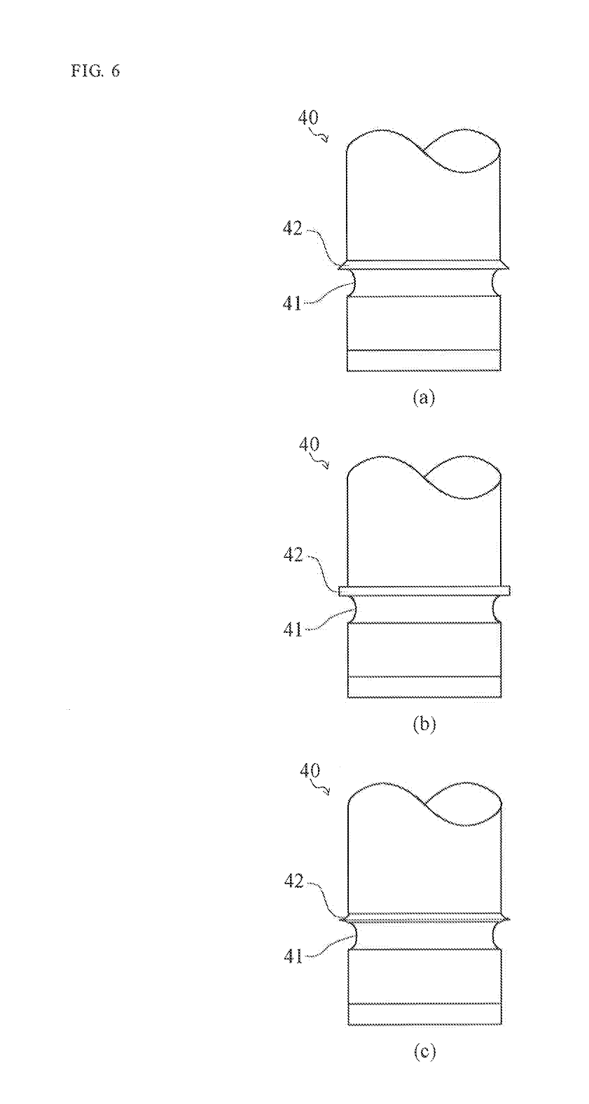

The sectional structure of the projection 42 is not limited to the semicircle. The projection may have the shape with a surface facing inside of the case 30, such as the triangle shape shown in FIG. 6(a) and the square shape shown in FIG. 6(b) both of which have a flat bottom.

Especially, FIG. 6(c) shows the preferable structure in which the projection 42 has concave surfaces at both upper and lower surfaces, and the lower surface of the projection 42 is smoothly continued to the upper end of the groove 41. In this case, the projection can be formed at one time by the threading for the groove 41. In other words, the projection 42 is preferably formed at the groove 41 by rolling or the like, or provided simultaneously with the groove 41.

The projection 42 with such structure can be easily formed and the manufacturing cost for the external terminal 40 formed with the groove 41 and the projection 42 disposed at the upper end of the groove.

As illustrated in FIG. 3, the current collecting terminal 45 includes a plate portion 46. The plate portion 46 is disposed at the upper end of the collecting terminal 45 and connected to the lower end of the external terminal 40. The plate portion 46 is laterally extended from the lower end of the terminal 40 beyond the inner periphery of the through hole 33.

Due to such structure, when the collecting terminal 45 is attached to the external terminal 40 and fixed to the through hole 33, the plate portion 46 and the projection 42 hold the inside of the insulating member 50, i.e., the contact surface between the insulating member 50 and the external terminal 40.

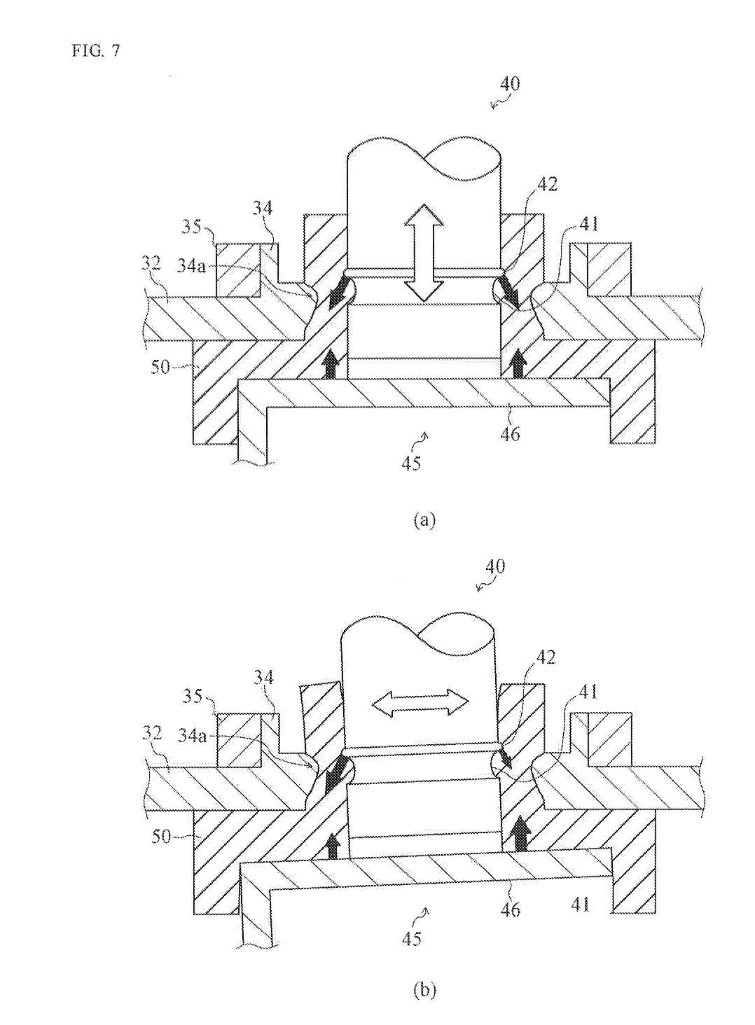

As described above, the plate portion 46 and the projection 42 of the collecting terminal 45 pinch the inside of the insulating member 50, and therefore, if the outer force acts on the terminal 40 in the axial or radial direction, the projection 42 prevents the upward flow of the insulating member 50 and at the same time the plate portion 46 prevents the downward flow of the insulating member 50 (see FIGS. 7 ((a) and (b))).

Accordingly, enough amount of the insulating member 50 can be secured in the sealing point, thereby maintaining the sealing property.

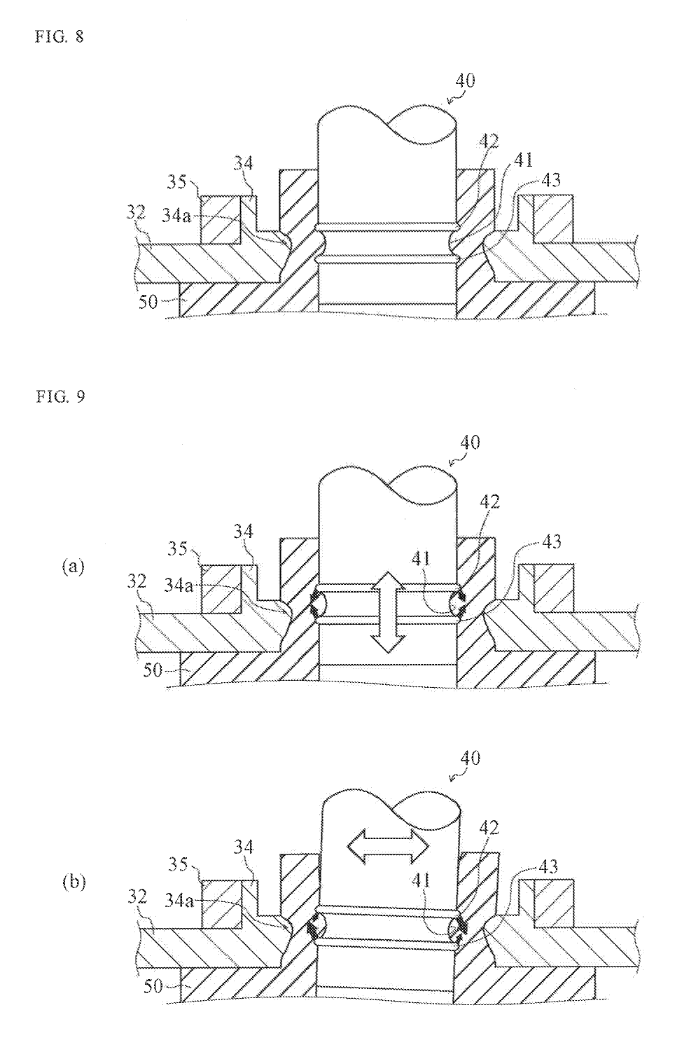

As depicted in FIG. 8, the external terminal 40 advantageously includes a second projection 43 in addition to the first projection 42. The second projection 43 is projected radially outward from the outside of the terminal 40. The second projection 43 is located lower than the lower edge line of the groove 41 that is the sealing point between the terminal 40 and the case 30.

The second projection 43 is a protrusion having a semicircular section, which is formed around the terminal 40. The projection 43 is provided below the groove 41, and formed continuously to the lower edge line of the groove 41. The structure of the second projection 43 is not limited to the semicircle as the first projection 42, namely, the second projection 43 includes at least the surface facing inside of the groove 41 (outside of the case 30). For instance, the second projection 43 may be formed in the structure of the first projection 42 shown in FIG. 6.

As above-described, the first projection 42 arranged above the groove 41 and the second projection 43 arranged below the groove 41 hold the insulating member 50 at the sealing point. If the outer force acts on the external terminal 40 in the axial direction or radial direction, the lower surface of the first projection 42 stops the upward flow of the insulating member 50 and the upper surface of the second projection 43 stops the downward flow of the insulating member 50 (see FIGS. 9 ((a) and (b))).

Consequently, the insulating member 50 can be prevented from flowing out from the sealing point, thereby enhancing the sealing property of the fixing point between the case 30 and the terminal 40.

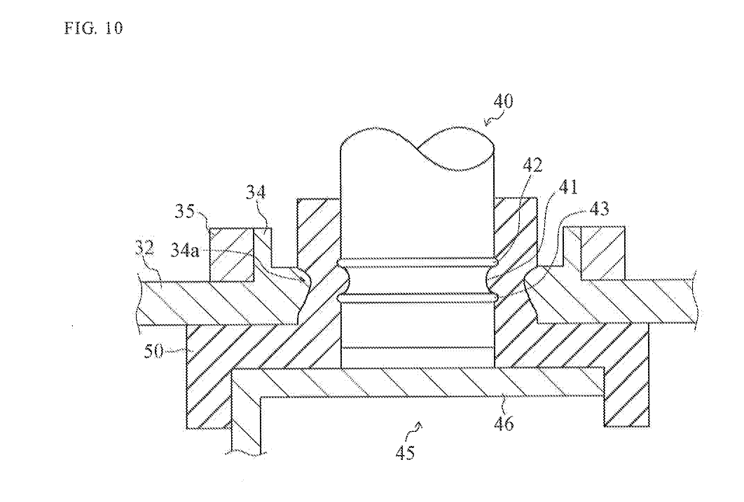

FIG. 10 depicts the more preferable embodiment, in which the external terminal 40 includes the first and second projections 42, 43 and the second projection 43 and the plate portion 46 of the current collecting terminal 45 pinch the insulating member 50 at the sealing point.

Such embodiment can have efforts as follows; the effect of the first projection 42, the effect of the second projection 43 and the effect of the plate portion 46 of the current collecting terminal 45.

### INDUSTRIAL APPLICABILITY

The present invention can be applicable to a battery which takes out an external terminal from the outside of a case, and particularly to a technique of improving the sealing property in the fixing point of the external terminal and the case.

### DESCRIPTION OF NUMERALS

10: battery, 30: case, 40: external terminal, 42: projection, 43: second projection, 45: current collecting terminal, 46: plate portion, 50: insulating member

1. A battery comprising:
a case provided with through holes;
external terminals fixed in the through holes of the case, projecting outward;
insulating members interposed between the case and the external terminals;
flanged portions located at the periphery of the through holes, standing out from the case; and
reinforcing members located around the flanged portions to reinforce strength thereof in radial direction,
wherein the flanged portions are pressed and plastically deformed so as to generate a sticking force between the external terminals and the through holes by the plastically deformed portion, whereby the external terminals are fixed to the through holes, and
wherein each of the external terminals comprises a first projection formed at outer side of the portion where the sticking force acts, projecting radially outward from the outside of the external terminal.

2. The battery according to claim 1,
wherein each of the external terminals comprises a groove formed at the portion where the sticking force acts, and the first projection is located outer side of the groove, and
wherein each of the external terminals further comprises a second projection formed at inner side of the groove, projecting radially outward from the outside of the external terminal.

3. The battery according to claim 2,
wherein the first and second projections are formed continuously to the edges of the groove.

4. The battery according to claim 1, further comprising:
current collecting terminals connecting a power generating element and the external terminals, each of the current collecting terminals connected to the inner end of the external terminal and extending beyond the outer periphery of the external terminal,
wherein each of the current collecting terminals holds the inside of the insulating member with the first or second projection.
